(19) United States
(12) Patent Application Publication
(10) Pub. No.: US 2016/0047317 A1
(43) Pub. Date: Feb. 18, 2016

(54) FUEL INJECTOR ASSEMBLIES IN COMBUSTION TURBINE ENGINES

(71) Applicant: General Electric Company, Schenectady, NY (US)

(72) Inventors: Christopher Paul Willis, Greenville, SC (US); William Michael Poschel, Greenville, SC (US); Lucas John Stoia, Taylors, SC (US); Patrick Benedict Melton, Horse Shoe, NC (US); Vaibhav Nadkarni, Bangalore (IN); Chandrasekhar Pushkaran, Bangalore (IN)

(73) Assignee: General Electric Company

(21) Appl. No.: 14/459,397

(22) Filed: Aug. 14, 2014

(51) Int. Cl. F02C 7/22

(52) U.S. Cl. CPC F02C 7/22

(57) ABSTRACT

A downstream nozzle for use in a combustor that includes an inner radial wall defining a combustion zone downstream of a primary nozzle and an outer radial wall surrounding the inner radial wall so to form a flow annulus therebetween. The downstream nozzle may include: an injector tube extending between the outer radial wall and the inner radial wall; a first plenum adjacent to the injector tube, and, inboard of the ceiling, a floor disposed between the inner radial wall and the outer radial wall. A feed passage may connect the first plenum to an inlet formed outboard of the outer radial wall and impingement ports may be formed through the floor of the first plenum.

### BACKGROUND OF THE INVENTION

The present invention relates to combustion systems in gas turbine engines, and more particularly, to apparatus and systems regarding nozzles or fuel injectors disposed downstream of the primary nozzles in certain types of combustors.

Multiple designs exist for staged combustion in combustion turbine engines (also “gas turbines”), but most are complicated assemblies consisting of a plurality of tubing and interfaces. As will be appreciated, one kind of staged combustion system commonly used in gas turbines is referred to as “late lean” injection systems, which includes injectors positioned downstream of the primary nozzles of the combustor. In this type of system, late fuel injectors are located downstream of the primary nozzle. These injectors may be positioned toward the aft region of the combustion zone. As one of ordinary skill in the art will appreciate, combusting a fuel/air mixture at this downstream location may be used to improve NOx emissions. NOx, or oxides of nitrogen, is one of the primary undesirable air polluting emissions produced by gas turbines burning conventional hydrocarbon fuels. Late lean injection systems may also function as an air bypass, which may be used to improve carbon monoxide or CO emissions during “turn down” or low load operation. Late lean injection systems also may provide other operational benefits.

Conventional late lean injection assemblies are expensive to manufacture for new gas turbine units and are difficult to retrofit into existing units. One of the reasons for this is the complexity of conventional late lean injection systems, particularly those components of the system associated with fuel and air delivery. The many parts associated with these systems must be designed to withstand the extreme thermal and mechanical loads of the turbine environment, which significantly increases manufacturing and installation cost. Conventional late lean injection assemblies have a high risk for fuel leakage, which can result in auto-ignition, flame holding, unit damage and safety issues.

Additionally, these systems require injector tubes for carrying a fuel and/or air mixture across the flow annulus so that the mix may be injected into an aft portion of the combustion zone. Specifically, such injector tubes bisect the flow annulus and thereby form significant obstructions to the flow of compressed air moving therethrough, which, as will be appreciated, may negatively impact performance in several ways. For example, the downstream wake or eddy caused by the injector tube disturbs the flow through the flow annulus and may lead to an uneven distribution of flow characteristics. As the compressed air moves toward the forward portion of the combustor for introduction to the fuel within the primary nozzles, nonuniform flow may negatively affect the resulting combustion. This can decrease the efficiency of the engine, as well as impact emission levels. As will be appreciated, levels of unwanted emissions typically decrease when compressed air is delivered to the primary nozzle having uniform characteristics, whereas nonuniform characteristics that produce uneven combustion result in raised emission levels. As a result, there is a need for downstream injector apparatus and systems that decrease the formation of such flow disturbances that are typical with conventional designs.

In addition, the wake that forms downstream of the injector tubes may negatively affect cooling within the region. It will be appreciated that the air moving through the flow annulus provides cooling to the inner radial wall that defines the combustion zone. This cooling allows the inner radial wall to withstand the high temperatures that enable more efficient engines. The downstream wake associated with injector tubes interrupts this flow, particularly with regard to the area on the inner radial wall positioned just downstream of an injector tube. More specifically, the injector tube interrupts the portion of the air moving through the flow annulus that otherwise was meant to convectively cooled that area. To the extent that this issue may be mitigated, combustor part life may be extended. Accordingly, there is a need for novel and innovative downstream injector configurations that avoid impacting annulus cooling in this way.

### BRIEF DESCRIPTION OF THE INVENTION

The present application thus describes a downstream nozzle for use in a combustor that includes an inner radial wall defining a combustion zone downstream of a primary nozzle and an outer radial wall surrounding the inner radial wall so to form a flow annulus therebetween. The downstream nozzle may include: an injector tube extending between the outer radial wall and the inner radial wall; a first plenum adjacent to the injector tube, and, inboard of the ceiling, a floor disposed between the inner radial wall and the outer radial wall. A feed passage may connect the first plenum to an inlet formed outboard of the outer radial wall and impingement ports may be formed through the floor of the first plenum.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 is a section view of a gas turbine engine in which embodiments of the present invention may be used.

FIG. 2 is a section view of a conventional combustor in which embodiments of the present invention may be used.

FIG. 3 is an enlarged section view of a combustor having a downstream or late fuel injector according to a conventional design.

FIG. 4 is a sectional view of a downstream fuel injector that includes aspects of the present invention.

FIG. 5 sectional perspective view of a downstream fuel injector in accordance with embodiments of the present invention.

FIG. 6 is a perspective view of a portion of a downstream fuel injector in accordance with certain embodiments of the present invention.

FIG. 7 is a simplified sectional profile view of a downstream fuel injector in accordance with embodiments of the present invention.

FIG. 8 is a perspective view of a portion of a downstream fuel injector in accordance with an alternative embodiment of the present invention.

FIG. 9 is a top view of the embodiment shown in FIG. 8.

FIG. 10 is a perspective view of a portion of a downstream fuel injector in accordance with an alternative embodiment of the present invention.

FIG. 11 is a top view of the embodiment shown in FIG. 10.

### DETAILED DESCRIPTION OF THE INVENTION

In the following text, certain terms have been selected to describe the present invention. To the extent possible, these terms have been chosen based on the terminology common to the field. Still, it will be appreciate that such terms often are subject to differing interpretations. For example, what may be referred to herein as a single component, may be referenced elsewhere as consisting of multiple components, or, what may be referenced herein as including multiple components, may be referred to elsewhere as being a single component. In understanding the scope of the present invention, attention should not only be paid to the particular terminology used, but also to the accompanying description and context, as well as the structure, configuration, function, and/or usage of the component being referenced and described, including the manner in which the term relates to the several figures, as well as, of course, the precise usage of the terminology in the appended claims.

Because several descriptive terms are regularly used in describing the components and systems within turbine engines, it should prove beneficial to define these terms at the onset of this section. Accordingly, these terms and their definitions, unless specifically stated otherwise, are as follows. The terms “forward” and “aft”, without further specificity, refer to directions relative to the orientation of the gas turbine. That is, “forward” refers to the forward or compressor end of the engine, and “aft” refers to the aft or turbine end of the engine. It will be appreciated that each of these terms may be used to indicate movement or relative position within the engine. The terms “downstream” and “upstream” are used to indicate position within a specified conduit relative to the general direction of flow moving through it. (It will be appreciated that these terms reference a direction relative to an expected flow during normal operation, which should be plainly apparent to anyone of ordinary skill in the art.) The term “downstream” refers to the direction in which the fluid is flowing through the specified conduit, while “upstream” refers to the direction opposite that.

Thus, for example, the primary flow of working fluid through a turbine engine, which consists of air through the compressor and then becoming combustion gases within the combustor and beyond, may be described as beginning at an upstream location at an upstream end of the compressor and terminating at an downstream location at a downstream end of the turbine. In regard to describing the direction of flow within a common type of combustor, as discussed in more detail below, it will be appreciated that compressor discharge air typically enters the combustor through impingement ports that are concentrated toward the aft end of the combustor (relative to the combustors longitudinal axis and the aforementioned compressor/turbine positioning defining forward/aft distinctions). Once in the combustor, the compressed air is guided by a flow annulus formed about an interior chamber toward the forward end of the combustor, where the air flow enters the interior chamber and, reversing it direction of flow, travels toward the aft end of the combustor. Coolant flows through cooling passages may be treated in the same manner.

Given the configuration of compressor and turbine about a central common axis as well as the cylindrical configuration common to many combustor types, terms describing position relative to an axis will be used. In this regard, it will be appreciated that the term “radial” refers to movement or position perpendicular to an axis. Related to this, it may be required to describe relative distance from the central axis. In this case, if a first component resides closer to the central axis than a second component, it will be described as being either “radially inward” or “inboard” of the second component. If, on the other hand, the first component resides further from the central axis than the second component, it will be described herein as being either “radially outward” or “outboard” of the second component. Additionally, it will be appreciated that the term “axial” refers to movement or position parallel to an axis. Finally, the term “circumferential” refers to movement or position around an axis. As mentioned, while these terms may be applied in relation to the common central axis that extends through the compressor and turbine sections of the engine, these terms also may be used in relation to other components or sub-systems of the engine. For example, in the case of a cylindrically shaped combustor, which is common to many machines, the axis which gives these terms relative meaning is the longitudinal central axis that extends through the center of the cross-sectional shape, which is initially cylindrical, but transitions to a more annular profile as it nears the turbine.

The following description provides examples of both conventional technology and the present invention, as well as, in the case of the present invention, several exemplary implementations and explanatory embodiments. However, it will be appreciated that the following examples are not intended to be exhaustive as to all possible applications the invention. Further, while the following examples are presented in relation to a certain type of turbine engine, the technology of the present invention also may be applicable to other types of turbine engines as would the understood by a person of ordinary skill in the relevant technological arts.

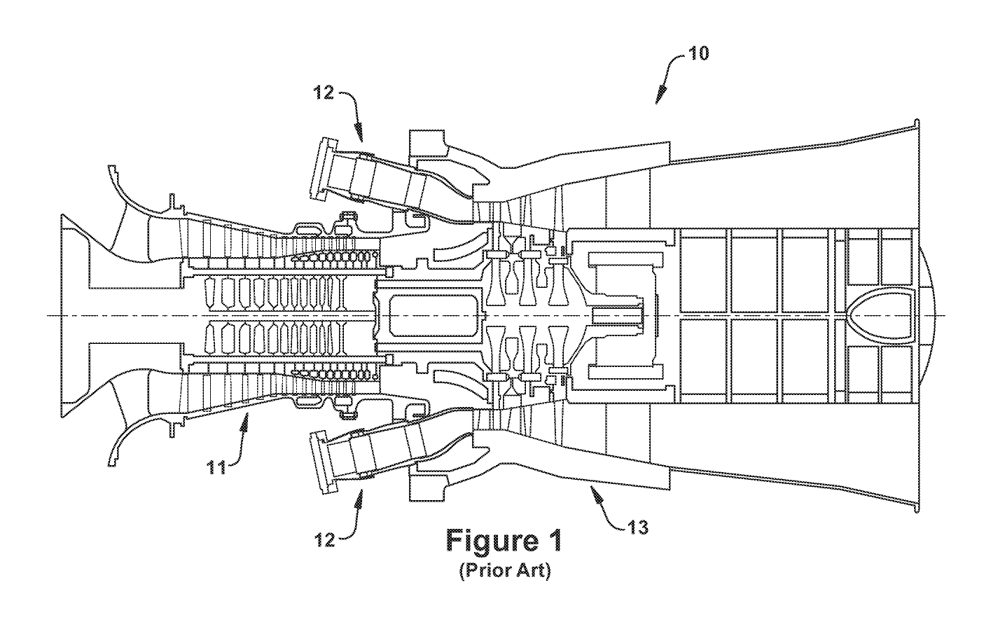

FIG. 1 is a cross-sectional view of a known gas turbine engine 10 in which embodiments of the present invention may be used. As shown, the gas turbine engine 10 generally includes a compressor 11, one or more combustors 12, and a turbine 13. It will be appreciated that a flowpath is defined through the gas turbine 10. During normal operation, air may enter the gas turbine 10 through an intake section, and then fed to the compressor 11. The multiple, axially-stacked stages of rotating blades within the compressor 11 compress the air flow so that a supply of compressed air is produced. The compressed air then enters the combustor 12 and directed through a nozzle, within which it is mixed with a supply of fuel so to form an air-fuel mixture. The air-fuel mixture is combusted within a combustion zone portion of the combustor so that a high-energy flow of hot gases is created. This energetic flow of hot gases then becomes the working fluid that is expanded through the turbine 13, which extracts energy from it.

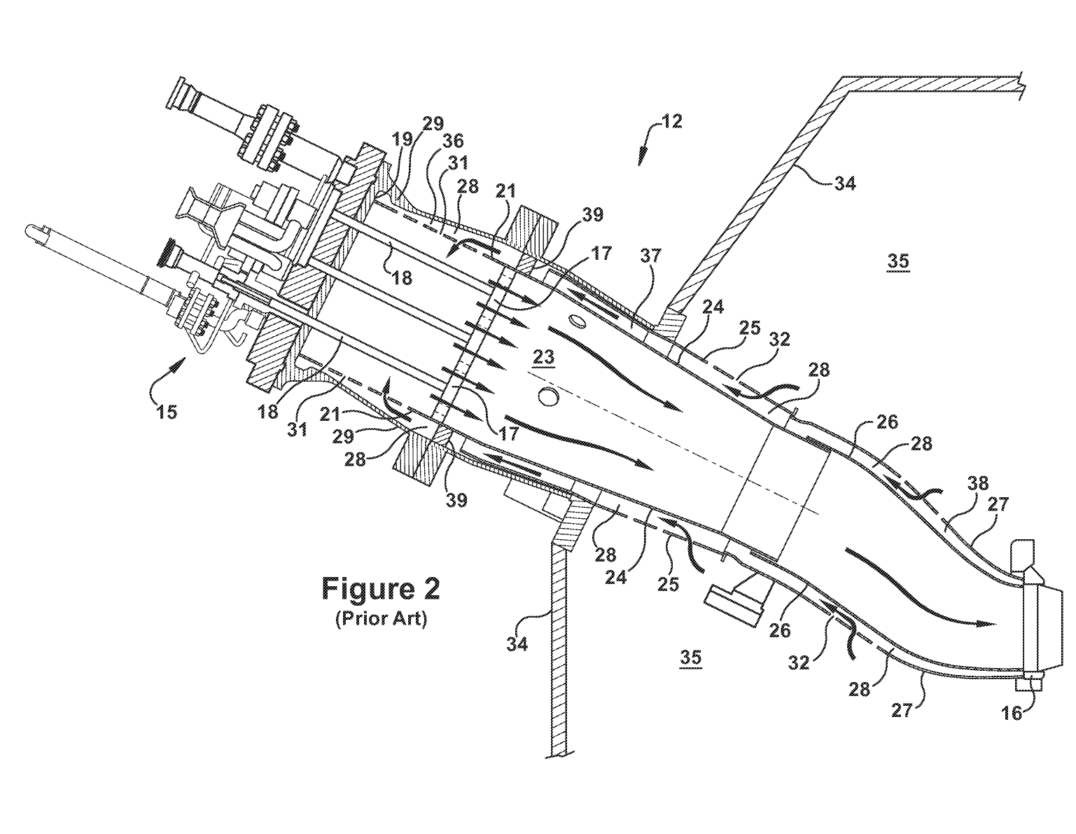

FIG. 2 illustrates an exemplary combustor 12 in which embodiments of the present invention may be used. As one of ordinary skill in the art will appreciate, the combustor 12 is axially defined by a forward end, which typically is referred to as a head end 15, and an aft end, which may be defined by an aft frame 16 that connects the combustor 12 to the turbine 13. A primary nozzle 17 may be positioned toward the forward end of the combustor 12. The primary nozzle 17 is the component brings together and mixes much of the fuel and air that is combusted within the combustor 12. As illustrated, the head end 15 generally provides the various manifolds, apparatus, and/or fuel lines 18 that provide the fuel to the nozzle 17. The head end 15 also may include an end cover 19 that forms the forward axial boundary of the large cavity formed within the combustor 12, through which the flow path of the working fluid is defined.

The interior of the combustor, as illustrated, may be divided into several smaller chambers that are configured to direct the working fluid along a desired path. These may include a first chamber that is typically defined within a component referred to as a cap assembly 21. The cap assembly 21 houses and structurally supports the primary nozzle 17, which, as illustrated, may be positioned at an aft end of it. In general, the cap assembly 21 extends aftward from a connection it makes with the end cover 19, and is surrounded by a combustor casing 29 that is formed about it. It will be appreciated that the cap assembly 21 and the combustor casing 29 form an annulus shaped flowpath between them, which, as discussed in more detail below, may continue in an aftward direction. This flowpath will be referred to herein as annulus flowpath 28. As illustrated, a second chamber may be positioned just aftward of the primary nozzle 17. Within the second chamber, a combustion zone 23 is defined where the fuel and air mixture brought together in the nozzle 17 is combusted. The combustion zone 23 may be circumferentially defined by a liner 24. From the liner 24, the second chamber may extend through a transition section toward the connection the combustor 12 makes with turbine 13. Though other configurations are also possible, within this transition section, the cross-sectional area of the second chamber transitions from the circular shape of the combustion zone 23 to a more annular shape that is necessary for the injection of the combustion gases into the turbine 13.

Positioned about the liner 24 is a flow sleeve 25. The liner 24 and flow sleeve 25 may be cylindrical in shape and arranged in a concentric cylindrical configuration. In this manner, the flow annulus 28 formed between the cap assembly 21 and the combustor casing 29 is continued in an aftward direction. Similarly, as illustrated, an impingement sleeve 27 may surround the transition piece 26 so that the flow annulus 28 extends further aftward. According to the example provided, the flow annulus 28 may extend from approximately the end cover 19 to the aft frame 29. The flow sleeve 25 and/or the impingement sleeve 27 may include a plurality of impingement ports 32 that allow a flow of compressed air external to the combustor 12 access to the flow annulus 28. It will be appreciated that, as illustrated, a compressor discharge casing 34 may define about at least a portion of the combustor 12 a compressor discharge cavity 35. The compressor discharge cavity 35 may be configured to receive a supply of compressed air from the compressor 11 so that the supply of compressed air then enters the flow annulus 28 of the combustor 12 through the impingement ports 32. At least some of the impingement ports 32 may be configured to impinge the flow of air against the liner 24 and/or transition piece 26 so to provide efficient convective cooling to this region. Specifically, the impinged flow serves to convectively cool the exterior surfaces of the liner 24 and/or transition piece 26. Once in the flow annulus 28, the compressed air is directed toward the forward end of the combustor 12. Then, via the inlets 31 in the cap assembly 21, the compressed air is directed into the interior of the cap assembly 21 and fed toward the primary nozzle 17 where it is mixed with fuel.

It will be appreciated that the cap assembly 21/combustor casing 29, the liner 24/flow sleeve 25, and the transition piece 26/impingement sleeve 27 pairings extend the flow annulus 28 almost the entire axial length of the combustor 12. As used herein, the term “flow annulus 28” may be used generally to refer to this entire annulus or any portion thereof. Particular sections of the flow annulus 28 may be referred to herein more specifically with the following terminology: a forward annulus section 36 is defined as the section formed between the cap assembly 21 and the combustor casing 29; a mid-annulus section 37 is defined as the section formed between the liner 24 and the flow sleeve 25; and an aft annulus section 38 is defined as the section formed between the transition piece 26 and the impingement sleeve 27.

It will be appreciated that the cap assembly 21 and the combustion zone 23 defined by the liner 24 and/or transition piece 26 may be described as forming axially stacked chambers, which, respectively, may be referred to herein as first and second chambers. As illustrated, such first and second chambers are separated at the primary nozzle 17. Additionally, the concentrically arranged cylindrical walls which form the flow annulus 28 may be referred to herein as inner and outer radial walls.

The primary nozzle 17 represents the primary fuel delivery component within the combustor 12, and, as illustrated, may be positioned at the aft end of the cap assembly 21. It will be appreciated that the manner in which the primary nozzle 17 brings together and mixes the fuel and air supplies may include many different configurations. For example, the primary nozzle 17 may include mixing tubes, swozzle designs, micro mixing technologies, etc. The primary nozzle 17 further may include an array of fuel injectors that are supplied with multiple fuel lines 18. The fuel, for example, may be natural gas, though other types of fuel are also possible.

As also indicated in FIG. 2, a plurality of vanes 41 may be provided within the flow annulus 28. The vanes 41 may take a variety of shapes. Typically, the vanes 41 have an airfoil shape or narrow profile, and extend between a connection formed with the inner radial wall and one formed with the outer radial wall. The vanes 41 may be circumferentially spaced about the circumference of the cap assembly 21. In this manner, the vanes 41 provide structural support to the cap assembly 21 and the primary nozzles 17 contained within it.

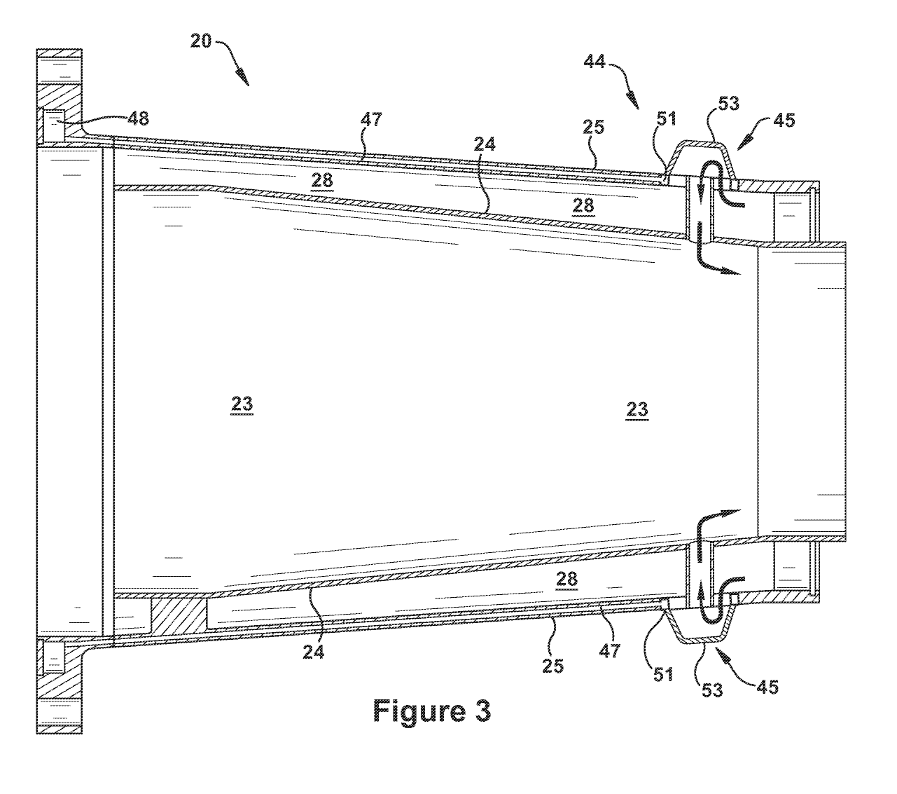

FIG. 3 provides a cross-sectional view of a liner 25/flow sleeve 26 assembly that includes a downstream injection system 44 (which may also be referred to as a late lean injection system) in accordance with certain aspects of the present invention. As used herein, a “downstream injection system” is a system for injecting a mixture of fuel and air into the flow of working fluid at a point downstream of the primary nozzle 17 and upstream of the turbine 13. In general, one of the objectives of downstream injection systems include enabling fuel combustion occurring downstream of primary combustors/primary combustion zone. This type of operation may be used to improve NOx emission performance. As shown, the late fuel injection system 44 includes a downstream nozzle 45, within which a supply of fuel and air are brought together and injected into a downstream portion of the combustion zone 23, as indicated. The system 44 may also include a fuel passageway 47 defined within the flow sleeve 26. The fuel passageway 47 may connect at an upstream end with a fuel manifold 48, which, as indicated, may be contained within a flow sleeve flange, though other configurations are also possible. The fuel passageway 47 may extend from the fuel manifold 48 to a fuel plenum 49 formed within the downstream nozzle 45.

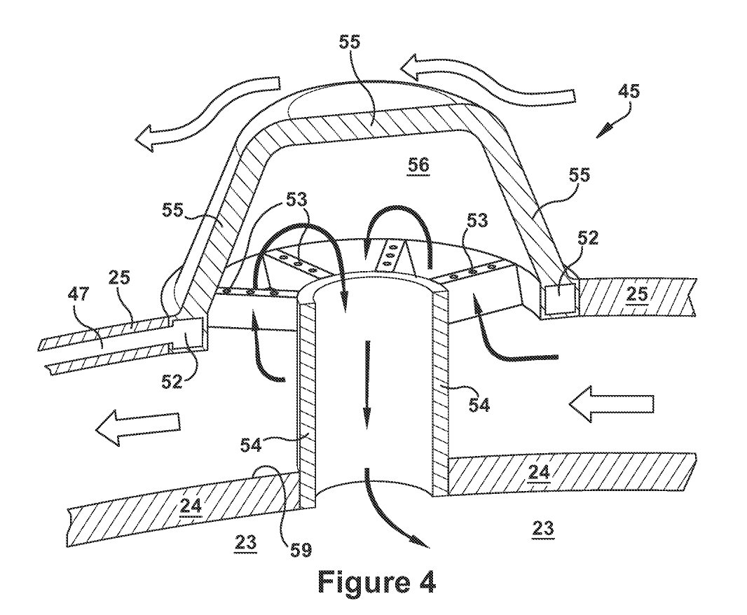

As indicated in FIG. 4, the downstream nozzle 45 may include a fuel injector 51 that includes a fuel plenum 52 supplying a number of fuel ports 53 positioned within the downstream nozzle 45 so to mix fuel with a supply of air extracted from the flow annulus 20 or some other location. A transfer or injector tube 54 then may carry the fuel/air mixture across the flow annulus 28 for injection into the combustion zone 23. More specifically, the injector tube 54 provides a conduit for directing the fuel/air mixture across the flow annulus 27 where it then may be injected into the flow of hot gas within the liner 24 for combustion. As illustrated, a cover or air shield 55 may be provided so to form an chamber 56 within which the fuel/air mixture may be brought together for mixing. It will be appreciated that the air shield 55 also serves to substantially isolate the downstream nozzle 45 from the compressor discharge cavity 35 that surrounds it.

It will be appreciated that the downstream nozzle 45 may also be installed in similar fashion at positions further forward or aft in a combustor 12 than those shown in the various figures, or, for that matter, anywhere where a flow assembly is present that has the same basic configuration as that described above for the liner 24/flow sleeve 25 assembly. For example, using the same basic components, the downstream nozzle 45 also may be positioned within the transition piece 26/impingement sleeve 27 assembly. As one of ordinary skill in the art will appreciate, this configuration may be advantageous given certain criteria and operator preferences. While the several provided figures are directed toward an exemplary embodiment within the liner 24/flow sleeve 25 assembly, it will be appreciated that this is not meant to be limiting. Accordingly, when the description below refers to an “outer radial wall”, it will be appreciated that, unless stated otherwise, this could refer to a flow sleeve 25, an impingement sleeve 27, or similar component. And when the description below refers to an “inner radial wall”, it will be appreciated that, unless stated otherwise, this could refer to the liner 24, the transition piece 25, or similar component.

One particular issue that relates to the usage of such downstream nozzles 45 is the negative effect of the wake caused by the injector tube 54 within the flow annulus 28. As mentioned, the wake can lead to a poorly mixed flow at the head end that negatively impacts combustion and NOx emissions. The wake also may negatively impact the cooling of the inner radial wall just downstream of the injector tube 54, which, as indicated in FIG. 4, will be referred to herein as “target area 59.” Specifically, the “dead zone” that occurs just downstream of the injector tube 54 impacts the cooling to the target area by interrupting the flow and thereby negatively affecting the heat transfer coefficient.

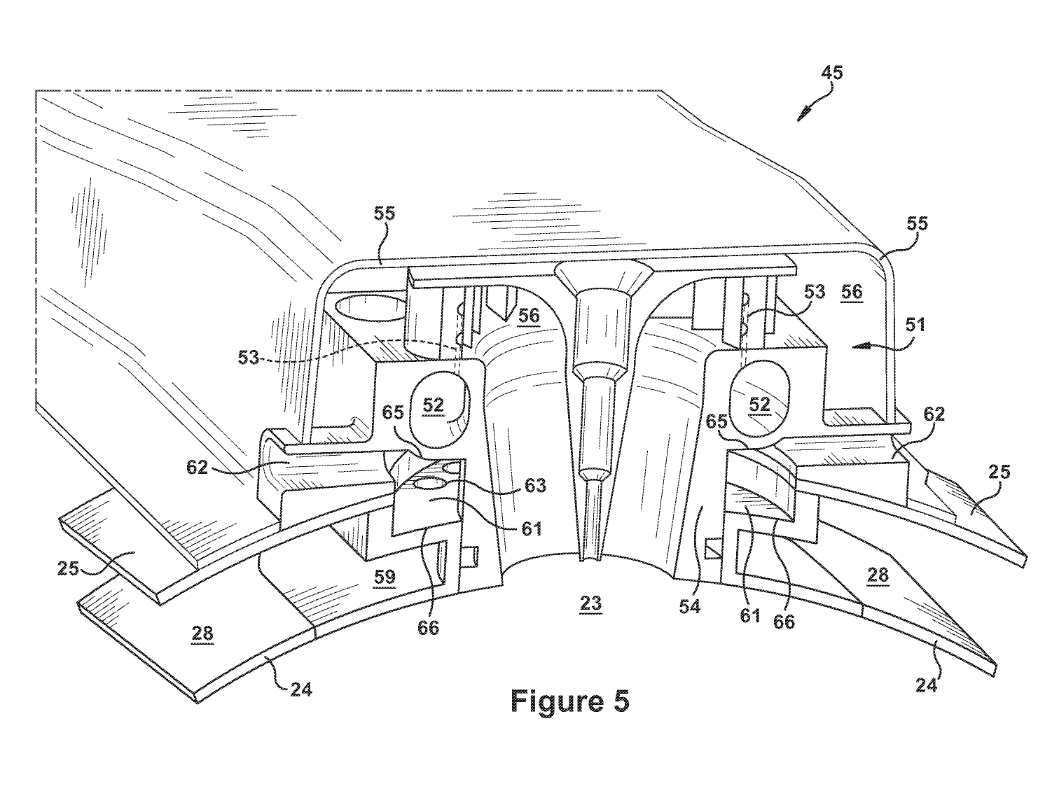

FIGS. 5 through 7 provide embodiments of downstream fuel nozzles 40 that, in accordance with the present invention, may be used to alleviate the negative effects associated with injector tubes 54 that interrupt the flow annulus 28. In general, as discussed in more detail below, a plenum 52 is provided within the flow annulus 28 that is fed with a supply of compressed air from the compressor discharge cavity 35 and a flow from the plenum 52 is directed by a plurality of impingement ports 63 into the area where the wake occurs so to lesson it while providing supplemental cooling to the target area. The plenum 61 and the impingement ports 63 may be sized so to provide adequate cooling while providing enough feed air to “fill in” the wake location behind the injector tube 54 so to eliminate any distribution issues at the head end. Additionally, an upstream nose feature 68 may be provided at the upstream side of the injector tube 54 to enhance the aerodynamic profile of the injector tube so to decrease the resulting wake. By providing even air distribution to the head end, the primary nozzle 17 will receive even air distribution, providing even fuel/air mixture which will allow the head end to operate at peak performance, maximizing power output while minimizing emissions. By cooling the target area 69, the part life of the liner will be increased, which will increase the time between combustion intervals and reducing repair costs associated with damaged hardware.

The downstream nozzle 45 may include an injector tube 54 that extends between the outer radial and the inner radial wall. Between the outer radial wall and the inner radial wall, the injector tube 54 may include solid structure configured to separate a flow moving through the injector tube 54 from the flow through the flow annulus. As before, depending on the axial location of the downstream nozzle 45, the outer radial wall may include the combustor casing 29, the flow sleeve 25, or the impingement sleeve 27. Respectively, the inner radial wall may include the cap assembly 21, the liner 14, or the transition piece 26. In a preferred embodiment, as illustrated in FIG. 3, the outer radial wall is the flow sleeve 25 and the inner radial wall is the liner 44. As illustrated, a plenum 61 (which may be referred to herein as the “first plenum 61”) may be formed adjacent to the injector tube 54. The first plenum 61 may include a ceiling 65 and a floor 66. As used herein, the ceiling 65 is the outer radial boundary of the first plenum 61, while the floor 66 is the inner radial boundary. According to preferred embodiments, the floor 66 is disposed between the inner radial wall and the outer radial wall. As illustrated, one or more feed passages 62 are provided that connect the first plenum 61 to an inlet formed outboard of the outer radial wall. The downstream nozzle 45 also includes impingement ports 63 that are formed through the floor 66 in such a way that a pressurized fluid within the first plenum 61 may be expelled and to the flow annulus 28.

According to the present invention, the configuration of the first annulus 61 may be varied. As illustrated, a preferred embodiment includes at least a portion of the first plenum 61 being positioned adjacent to a downstream side of the injector tube 54. It will be appreciated that, if defined relative to an expected flow through the flow annulus 28 during operation, the injector tube 54 may be described as having an upstream side and a downstream side. As described, during operation compressed air from the compressor 11 is delivered to a combustor discharge cavity 35 formed about the combustor. The compressed air then enters the flow annulus 28 through the ports 32 formed within the impingement sleeve 27 and flow sleeve 25 so to develop a fast-moving flow through the annulus 28 that is directed toward the forward end of the combustor 12. Accordingly, given this direction of flow through the annulus 28, the downstream side of the injector tube 54 is the forward facing side (i.e., the side facing the head end 15 of the combustor 12). In an alternative embodiment, the first plenum 61 is formed adjacent to only this downstream side of the injector tube 54. According to a preferred embodiment, as illustrated, the first plenum 61 is formed as annulus about the injector tube 54. In this case, the impingement ports 63 may be dispersed about the floor 66 of the first plenum 61 so that they are concentrated or formed exclusively in the downstream portion of the first plenum 61.

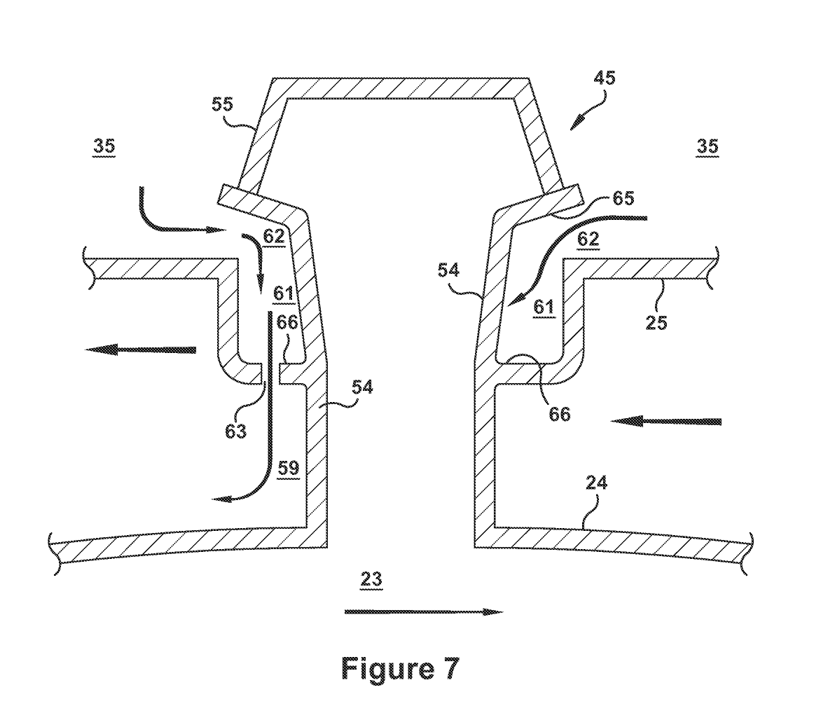

The target area 59 is a region on the outer surface of the inner radial wall that occurs just downstream and adjacent to of the injector tube 54. The target area 59, as mentioned, is the area most affected by the wake formed downstream of the injector tube 54. That is, the injector tube 54 interrupts the flow through the annulus 28 and negatively affects the convective cooling of the flow to the target area 59. According to preferred embodiments, the impingement ports 63 within the downstream portion of the first plenum 61 may be configured so to direct a pressurized fluid expelled from the first plenum 61 on to the target area 59. It will be appreciated that this supplemental flow of coolant may be used to address the cooling deficiencies within the target area 59 caused by the wake of the injector tube 54. The outflow of air through the impingement ports 63 also acts to “fill in” the air that was separated by the injector tube 54 so to minimize interruption and maximize uniformity within the flow as it is delivered to the primary nozzle 17. According to a preferred embodiment, the downstream portion of the first plenum 61 includes at least 8 of the impingement ports 63. The eight impingement ports 63 may be evenly spaced in a way that corresponds to the target area 59. As illustrated most clearly in FIG. 7, the first plenum 61 may include a cantilevered configuration in which the downstream section of the first plenum 61 juts from the downstream side of the injector tube 54. In such cases the target area 59 may be defined as the outer surface of the inner radial wall that is overhung by the downstream section of the first plenum 61. The impingement ports 63 may be oriented substantially perpendicular to a direction of flow through the flow annulus.

The floor 66 of the first plenum 61 may be positioned in proximity to the outer surface of the inner radial wall so to enhance the cooling effect that flow through the impingement ports 63 has. The ceiling 65 of the first plenum 61 may be positioned near the outer radial wall. The floor 66 of the first plenum 61 may include a planar configuration oriented substantially parallel to the outer surface of the inner radial wall. According to a preferred embodiment, the floor 66 of the first plenum 61 may be positioned approximately midway between the outer surface of the inner radial wall and the inner surface of the outer radial wall. The ceiling 65 of the first plenum 61 may be positioned just outboard the outer radial wall. According to an alternative embodiment, the ceiling 65 of the first plenum 61 may be positioned just inboard the outer radial wall.

As illustrated, the feed passage 62 may be configured so to extend through the outer radial wall between an inlet disposed outboard of the outer radial wall and an outlet disposed inboard of the outer radial wall and configured to fluidly communicate with the first plenum 61. As described, a compressor discharge casing 34 defines a compressor discharge cavity about the combustor. As illustrated, the inlet of the feed passage 62 may be configured to fluidly communicate with the compressor discharge cavity 35. According to alternative embodiments, a plurality of the feed passages 62 may be provided. As illustrated in FIGS. 5 and 7, two feed passages 62 may be provided and configured on substantially opposite sides of the downstream nozzle 45.

The downstream nozzle 45, as illustrated, may further include an air shield 55. The air shield 55 may include a wall extending outboard from an injector footprint defined upon an outer surface of the outer radial wall. The air shield 55 may be configured to substantially separate an interior of the downstream nozzle 45 from the compressor discharge cavity 35. According to a preferred embodiment, the feed passage 62 is configured to extend through the air shield 55 so to fluidly communicate with the compressor discharge cavity 35. It will be appreciated that supplying the first plenum 61 in this manner this will provide a flow with pressure sufficient to effectively cool the target area 59 while also prevent any possible backflow from the annulus 28.

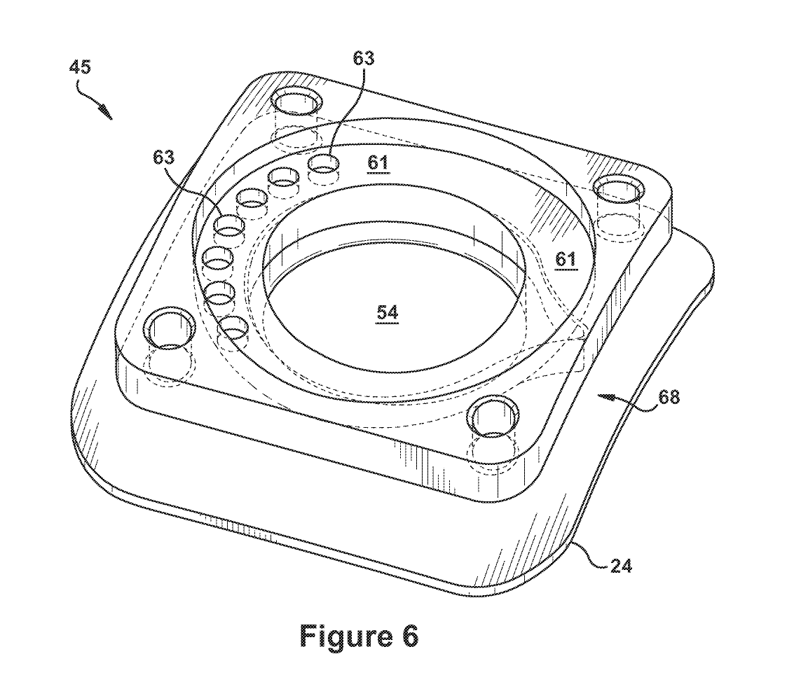

The upstream side of the injector tube 54, as illustrated in FIG. 6, may include an aerodynamic nose feature 68. The aerodynamic nose feature 68 may include an aerodynamic profile that mitigates the formation of the wake downstream of the injector tube 54. In a preferred by month, as illustrated, the aerodynamic nose feature 68 may include a narrowing profile that, at an upstream end, includes a sharp point. The aerodynamic nose feature may include an inboard position relative to the first plenum 61.

Similar to the downstream nozzle 45 shown in FIG. 4, the downstream nozzle 45 of FIGS. 5 through 7 may include a fuel injector 51 in which a fuel plenum 52 formed about the injector tube 54 supplies a number of fuel ports 53 designed to inject fuel into a supply of compressed air that is being directed into the injector tube 54. In a preferred embodiment, the fuel plenum 52 includes a connection to a fuel supply passageway formed within the outer radial wall. Other configurations for fuel delivery are also possible. As illustrated, the downstream nozzle 45 may also include a mixing plenum or chamber 56 for bringing the fuel and air together before directing the mixed flow into the injector tube 54. It will be appreciated that the chamber 56 connects to a first end of the injector tube 54, while a second end of the injector tube 54 connects to the combustion zone through the inner radial wall of the combustor 12. The downstream nozzle 45 may be included within a late lean injection system configure to inject a mixture of fuel and air within an aft end of the combustion zone defined by the liner. Such systems may include several downstream nozzles 45 that are arrayed circumferentially about the combustion zone 23.

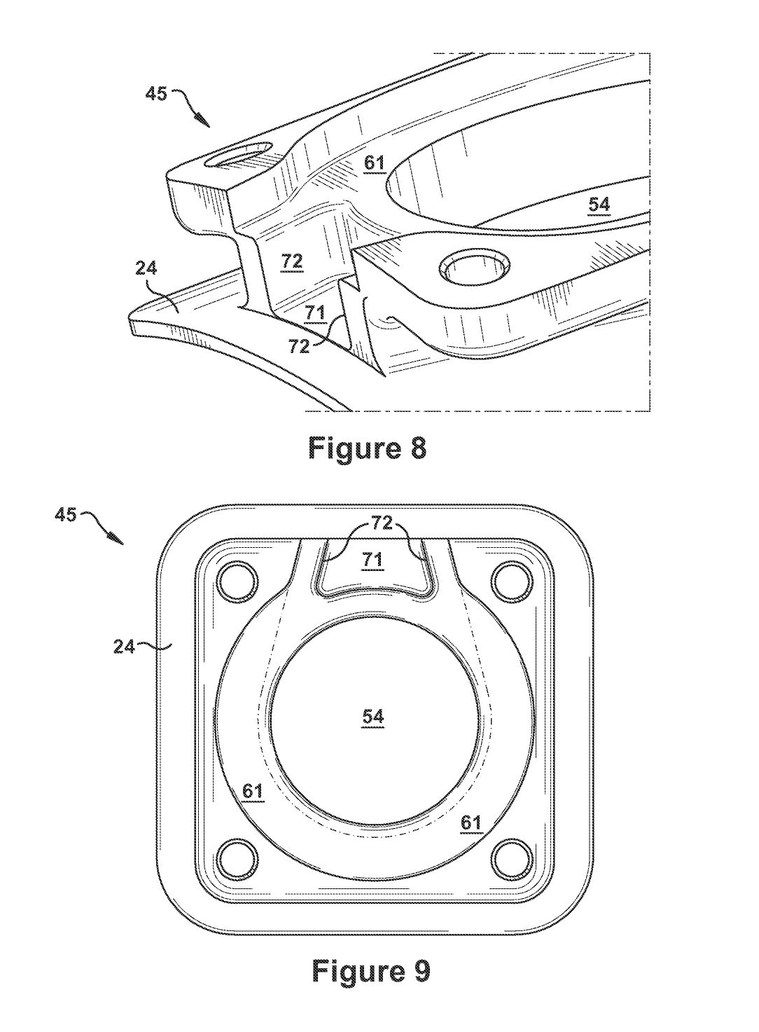

FIGS. 8 through 11 illustrate an alternative embodiment in which the impingement ports 63 are replaced by a slot 71 formed through the downstream portion of the floor 66 of the first plenum 61. Configured in this manner, the slot 71 may be used to direct a greater volume of air to the wake region that, as described, forms just downstream of the injector tube 54. This volume of air moving through the first plenum 61 and injected into the wake region may be tuned by varying the size of the slot 71 so that the disturbance to the annulus flow just downstream of the injector tube 54 is minimized. Referring to FIG. 9, the slot 71 may have a profile having sidewalls 72 that narrows the opening as the slot extends in the downstream direction. It will be appreciated that with this profile, the flow of air from the first plenum may be concentrated in the area most affected by the flow interruption by the injector tube 54. Also, the narrowing flow area of the tapered profile will increase the speed of the flow, which will enhance its cooling characteristics.

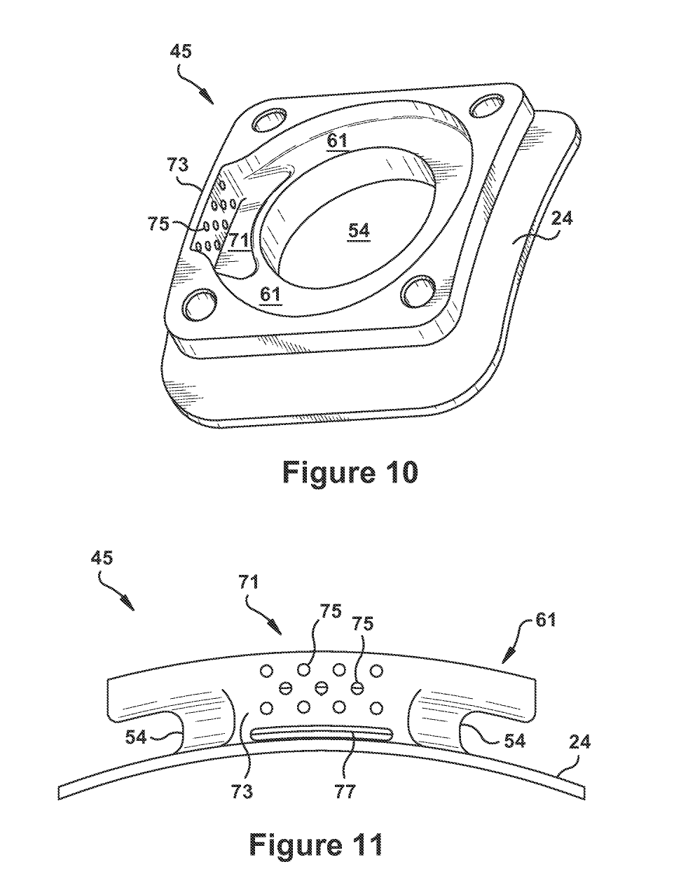

Referring to FIGS. 10 and 11, an alternative embodiment may include the slot 71 discussed above combined with a screen 73. As illustrated, the screen 73 may have a number of screen ports 75 that are aligned approximately parallel with the flow through the annulus. The screen ports 75 may serve to condition the flow of air being injected into annulus flow path so to limit aerodynamic losses. The screen ports 75 also may be used to meter the flow in this area. As illustrated, the screen 73 may also include a slit port 77 that is located along the inner radial edge of the screen 73. The slit port 77 may be aligned approximately parallel to the inner radial wall or liner 24, as illustrated. The slit port 75 may be used so to concentrate a flow of coolant along the outer surface of the liner 24. The slit port 77 may present another way by which the flow from the first plenum 61 is metered so to improve performance. It will be appreciated that the screen ports 75 condition the flow that is being injected so to alleviated the aerodynamic disturbance downstream of the injector tube 54, while the slit port 77 may be used to specifically address the cooling issues that are common.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A downstream nozzle in a combustor of a combustion turbine engine, wherein the combustor includes an inner radial wall defining a combustion zone downstream of a primary nozzle, and an outer radial wall surrounding the inner radial wall so to form a flow annulus therebetween, the downstream nozzle comprising:
an injector tube extending between the outer radial wall and the inner radial wall;
a first plenum adjacent to the injector tube, the first plenum including a ceiling and, inboard of the ceiling, a floor, wherein the floor is disposed between the inner radial wall and the outer radial wall;
a feed passage connecting the first plenum to an inlet formed outboard of the outer radial wall; and
a port formed through the floor of the first plenum.

2. The downstream nozzle according to claim 1, wherein the injector tube includes an upstream side and a downstream side defined relative an expected flow through the flow annulus during operation of the combustion turbine engine;
wherein a downstream portion of the first plenum is positioned adjacent to the downstream side of the injector tube and includes at least a plurality of the impingement ports; and
wherein an outer surface of the inner radial wall opposes an inner surface of the outer radial across the flow annulus.

3. The downstream nozzle according to claim 2, wherein the feed passage extends through the outer radial wall between an inlet disposed outboard of the outer radial wall and an outlet disposed inboard of the outer radial wall and configured to fluidly communicate with the first plenum.

4. The downstream nozzle according to claim 2, wherein the outer surface of the inner radial wall includes a target area defined just downstream of and adjacent to the injector tube; and
wherein the plurality of the impingement ports within the downstream portion of the first plenum are configured so to direct a pressurized fluid expelled therefrom toward the target area.

5. The downstream nozzle according to claim 4, wherein the downstream portion of the first plenum comprises at least 8 of the impingement ports; and
wherein the at least 8 impingement ports are evenly spaced so to correspond with the target area.

6. The downstream nozzle according claim 2, wherein the first plenum comprises a cantilevered configuration in which a downstream section of the first plenum juts from the downstream side of the injector tube;
wherein a target area comprises the outer surface of the inner radial wall that is overhung by the cantilevered downstream section of the first plenum; and
wherein the downstream section of the first plenum comprises a plurality of the impingement ports aimed at the target area.

7. The downstream nozzle according to claim 2, wherein the first plenum is configured to overhang a target area defined on the outer surface of the inner radial wall, the target area being disposed just downstream of the injector tube;
wherein the impingement ports comprise a configuration training each upon the target area; and
wherein the floor of the first plenum comprises a planar configuration oriented substantially parallel to the outer surface of the inner radial wall; and
wherein the floor of the first plenum is positioned approximately midway between the outer surface of the inner radial wall and the inner surface of the outer radial wall.

8. The downstream nozzle according to claim 7, wherein the ceiling of the first plenum is positioned just outboard the outer radial wall;
wherein the impingement ports are oriented substantially perpendicular to a direction of flow through the flow annulus;
wherein the downstream nozzle includes a plurality of the feed passages, the plurality of the feed passages including at least two feed passages configured on substantially opposite sides of the downstream nozzle.

9. The downstream nozzle according to claim 2, wherein a compressor discharge casing defines a compressor discharge cavity about the combustor; and
wherein the inlet of the feed passage is configured to fluidly communicate with the compressor discharge cavity.

10. The downstream nozzle according to claim 2, wherein the first plenum forms an annulus about the injector tube;
wherein the impingement ports are dispersed about the floor of the first plenum so to comprise a concentration within the downstream portion of the first plenum.

11. The downstream nozzle according to claim 2, wherein the upstream side of the injector tube comprises an aerodynamic nose feature.

12. The downstream nozzle according to claim 11, wherein the aerodynamic nose feature narrows to a sharp point aimed in an upstream direction relative the expected flow through the flow annulus; and
wherein the aerodynamic nose feature comprises an inboard position relative to the first plenum.

13. The downstream nozzle according to claim 2, wherein a compressor discharge casing defines a compressor discharge cavity about the combustor;
further comprising an air shield, the air shield including a wall extending outboard from an injector footprint defined upon an outer surface of the outer radial wall, the air shield configured to substantially separated an interior of the downstream nozzle from the compressor discharge cavity;
wherein the feed passage is configured to extend through the air shield so to fluidly communicate with the compressor discharge cavity.

14. The downstream nozzle according to claim 2, wherein the downstream nozzle further comprises:
a fuel plenum formed about the injector tube, the fuel plenum including a connection to a fuel supply passageway longitudinally within the outer radial wall; and
a mixing plenum configured to include an air feed and fuel injecting ports that each connect to the fuel plenum;
wherein the mixing plenum connects to a first end of the injector tube; and
wherein a second end of the injector tube connects to the combustion zone through the inner radial wall; and
wherein between the outer radial wall and the inner radial wall, the injector tube comprises separating structure configured to separate a flow moving through the injector tube from the flow moving through the flow annulus.

15. The downstream nozzle according to claim 14, wherein the inner radial wall comprises a liner and the outer radial wall comprises a flow sleeve.

16. The downstream nozzle according to claim 14, wherein the inner radial wall comprises a transition piece and the outer radial wall comprises an impingement sleeve.

17. The downstream nozzle according to claim 14, wherein the downstream nozzle comprises a late lean injection system configure to inject a mixture of fuel and air within an aft end of the combustion zone defined by the liner; and
wherein the flow annulus is configured to carry a supply of compressed air toward a cap assembly positioned at a forward end of the combustor within which the primary nozzle is housed.

18. The downstream nozzle according to claim 1, wherein the port comprises slot formed through a the floor of the first plenum, wherein the slot comprises a tapered profile that narrows as the slot extends downstream.

19. The downstream nozzle according to claim 18, wherein the slot includes a screen formed at a downstream wall, wherein the screen includes a plurality of ports and a slit port formed near and approximately parallel to the inner radial wall of the combustor.

20. A late lean injector in a combustor of a combustion turbine engine, wherein the combustor includes a liner defining a combustion zone downstream of a primary nozzle, and a flow sleeve surrounding the line so to form a flow annulus therebetween, the late lean injector comprising:
an injector tube extending between the outer radial wall and the inner radial wall;
a first plenum forming an annulus around the injector tube, the first plenum including a ceiling and, inboard of the ceiling, a floor, wherein the floor is disposed between the inner radial wall and the outer radial wall;
a feed passage connecting the first plenum to an inlet formed outboard of the outer radial wall; and
impingement ports formed through the floor of the first plenum;
wherein impingement ports are dispersed about the floor of the first plenum so to comprise a concentration within a downstream portion of the first plenum; and
wherein the outer surface of the inner radial wall includes a target area defined just downstream of and adjacent to the injector tube, and wherein the concentration of impingement ports within the downstream portion of the first plenum are aim at the target area.
